(19) United States
(12) Patent Application Publication
(10) Pub. No.: US 2011/0193805 A1
(43) Pub. Date: Aug. 11, 2011

(54) SCREEN CONTROL METHOD AND APPARATUS FOR MOBILE TERMINAL HAVING MULTIPLE TOUCH SCREENS

(75) Inventors: Soo Hyun PARK, Seoul (KR); Min Hwa JUNG, Seoul (KR)

(73) Assignee: SAMSUNG ELECTRONICS CO. LTD., Suwon-si (KR)

(21) Appl. No.: 13/014,985

(22) Filed: Jan. 27, 2011

(30) Foreign Application Priority Data
Feb. 10, 2010 (KR) 10-2010-0012477

(51) Int. Cl. G06F 3/041

(52) U.S. Cl. 345/173; 715/702

(57) ABSTRACT

A screen control method and apparatus for a mobile terminal including multiple touch screens are provided. The screen control method includes displaying at least one application screen on the touch screens, detecting touch gestures made on the touch screens, identifying the detected touch gestures made on the touch screens, and changing at least one of application screens on the touch screens according to the identified touch gestures. Hence, multiple touch screens can be controlled and a display screen can be changed by simple touch gestures.

### PRIORITY

This application claims the benefit under 35 U.S.C. §119(a) of a Korean patent application filed on Feb. 10, 2010 in the Korean Intellectual Property Office and assigned Serial No. 10-2010-0012477, the entire disclosure of which is hereby incorporated by reference.

### BACKGROUND OF THE INVENTION

1. Field of the Invention

The present invention relates to a mobile terminal including multiple touch screens. More particularly, the present invention relates to a screen control method and apparatus for a mobile terminal including multiple touch screens for controlling a screen display according to touch inputs.

2. Description of the Related Art

As a result of recent developments of mobile terminals, a mobile terminal has become a necessity of modern life. Mobile terminals have evolved into multimedia communication devices that can provide not only voice call services but also data transfer services and other supplementary services. More particularly, many users favor touch-enabled mobile terminals employing touch screen technology.

A standard touch-enabled mobile terminal includes a single touch screen. However, an ever increasing number of applications running on a mobile terminal has aggravated a problem of screen size restrictions. To solve this problem, a mobile terminal having two touch screens has been developed. Currently, User Interface (UI) features for controlling a display on the two touch screens have not been established.

Therefore, a need exists for a user interface feature for conveniently controlling two touch screens in a mobile terminal.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for controlling a screen display of a mobile terminal including multiple touch screens in a manner enhancing user convenience.

In accordance with an aspect of the present invention, a screen control method for a mobile terminal including multiple touch screens is provided. The method includes, displaying at least one application screen on the touch screens, detecting touch gestures made on the touch screens, identifying the detected touch gestures made on the touch screens, and changing at least one of application screens on the touch screens according to the identified touch gestures.

In accordance with another aspect of the present invention, a mobile terminal is provided. The terminal includes multiple touch screens for detecting touch gestures and for displaying application screens, and a control unit for controlling the multiple touch screens to detect touch gestures, for identifying the detected touch gestures, and for changing at least one of the application screens on the touch screens according to the identified touch gestures.

In an exemplary embodiment of the present invention, multiple touch screens may be controlled to change a screen display by simple touch gestures. The touch gestures are associated with intuitive actions of a user, thereby appealing to emotional sensitivity in the use of a mobile terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile terminal including two touch screens according to an exemplary embodiment of the present invention;

FIG. 2 is a block diagram of a mobile terminal including two touch screens according to an exemplary embodiment of the present invention;

FIG. 3 is a flowchart illustrating a screen control method for a mobile terminal including multiple touch screens according to an exemplary embodiment of the present invention;

FIG. 4 is a flowchart illustrating a screen control method for a mobile terminal including multiple touch screens according to an exemplary embodiment of the present invention;

FIG. 5A depicts a screen display change on a first touch screen and a second touch screen in response to downward touch-point move gestures according to an exemplary embodiment of the present invention;

FIG. 5B depicts a screen display change on a first touch screen and a second touch screen in response to upward touch-point move gestures according to an exemplary embodiment of the present invention;

FIG. 6 is a flowchart illustrating a screen control method for a mobile terminal including multiple touch screens according to an exemplary embodiment of the present invention;

FIG. 7A depicts a screen display change on a first touch screen and a second touch screen in response to upward touch-point move gestures according to an exemplary embodiment of the present invention;

FIG. 7B depicts a screen display change on a first touch screen and a second touch screen in response to downward touch-point move gestures according to an exemplary embodiment of the present invention;

FIG. 8 is a flowchart illustrating a screen control method for a mobile terminal including multiple touch screens according to an exemplary embodiment of the present invention;

FIG. 9A depicts a screen display change on a first touch screen and a second touch screen in response to upward touch-point move gestures according to an exemplary embodiment of the present invention;

FIG. 9B depicts a screen display change on a first touch screen and a second touch screen in response to downward touch-point move gestures according to an exemplary embodiment of the present invention;

FIG. 10 is a flowchart illustrating a screen control method for a mobile terminal including multiple touch screens according to an exemplary embodiment of the present invention;

FIG. 11A depicts a screen display change on a first touch screen and a second touch screen in response to upward touch-point move gestures according to an exemplary embodiment of the present invention;

FIG. 11B depicts a screen display change on a first touch screen and a second touch screen in response to downward touch-point move gestures according to an exemplary embodiment of the present invention;

FIG. 12 is a flowchart illustrating a screen control method for a mobile terminal including multiple touch screens according to an exemplary embodiment of the present invention;

FIG. 13A depicts a screen display change on a first touch screen and a second touch screen in response to a downward touch-point move gesture made on a first touch screen and an upward touch-point move gesture made on a second touch screen according to an exemplary embodiment of the present invention;

FIG. 13B depicts a screen display change on a first touch screen and a second touch screen in response to an upward touch-point move gesture made on a first touch screen and a downward touch-point move gesture made on a second touch screen according to an exemplary embodiment of the present invention;

FIG. 14 is a flowchart illustrating a screen control method for a mobile terminal including multiple touch screens according to an exemplary embodiment of the present invention; and

FIGS. 15A and 15B depict a screen display change on a first touch screen and a second touch screen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a mobile terminal. However, the present invention is not limited thereto, and is applicable to any touch-enabled device. The mobile terminal according to an exemplary embodiment of the present invention is a touch-enabled terminal and may include any information and communication device, such as a mobile communication terminal, a Portable Multimedia Player (PMP), a Personal Digital Assistant (PDA), a smart phone, a Moving Picture Expert Group (MPEG)-1 or 2 Audio Layer 3 (MP3) player, and the like.

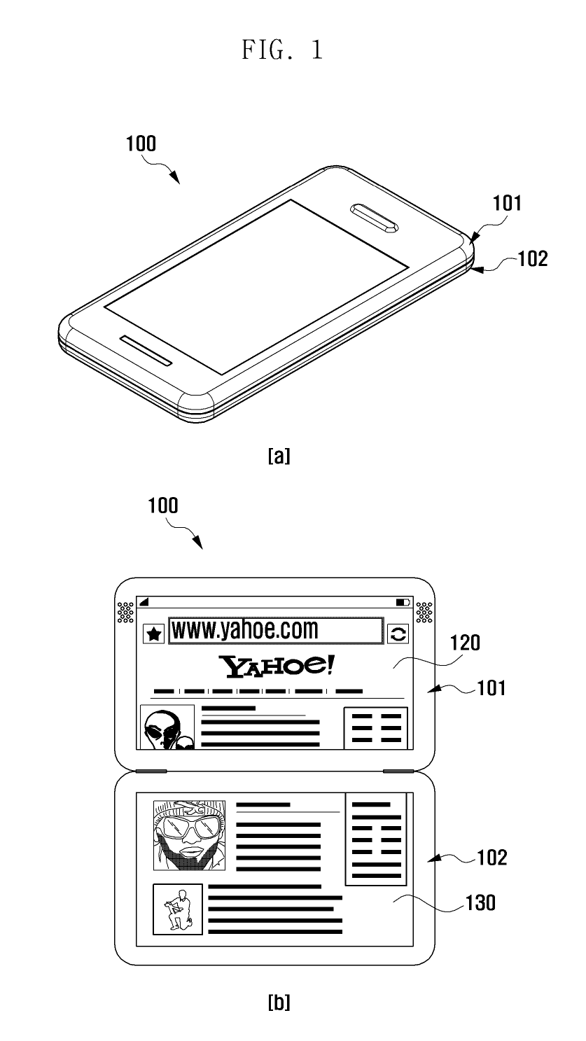

FIG. 1 illustrates a mobile terminal including two touch screens according to an exemplary embodiment of the present invention.

The mobile terminal according to an exemplary embodiment of the present invention provides a folder type mobile terminal with two touch screens that are exposed to the outside when opened. However, the present invention is not limited thereto, and may be applied to other types of mobile terminals. For example, the present invention may be applied to a slide type mobile terminal, which exposes one touch screen to the outside when closed and exposes two touch screens when opened.

Referring to FIG. 1, reference symbol [a] depicts an external appearance of the mobile terminal 100 in a closed state, and reference symbol [b] depicts the external appearance of the mobile terminal 100 in an opened state. The mobile terminal 100 is composed of a first body 101 and a second body 102. The first body 101 includes a first touch screen 120 at one side, and the second body 102 includes a second touch screen 130 at one side. In an exemplary implementation, the mobile terminal 100 may have more than two display units. That is, an additional display unit may be installed on the other side of the first body 101, and an additional display unit may be installed on the other side of the second body 102. As indicated by reference symbol [b], the mobile terminal 100 may output a web browser screen on the first touch screen 120 and second touch screen 130. The web browser screen corresponds to a case in which a single application screen is displayed on the two touch screens 120 and 130. Internal components of the mobile terminal 100 will be described below.

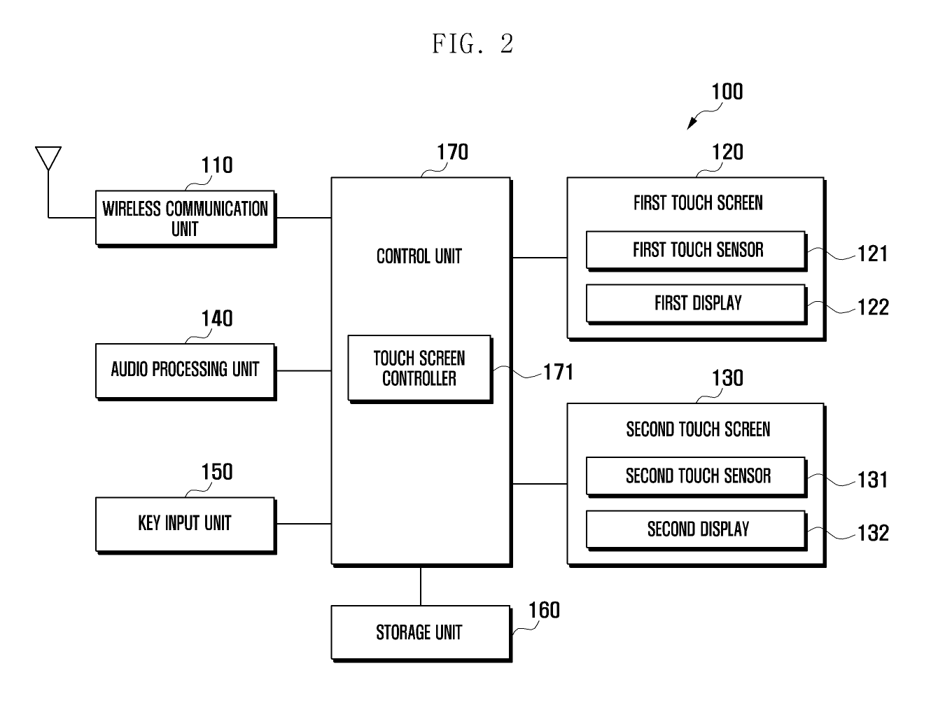

FIG. 2 is a block diagram of a mobile terminal including two touch screens according to an exemplary embodiment of the present invention.

Referring to FIG. 2, the mobile terminal 100 includes a wireless communication unit 110, a first touch screen 120, a second touch screen 130, an audio processing unit 140, a key input unit 150, a storage unit 160, and a control unit 170.

The wireless communication unit 110 transmits and receives data for wireless communication of the mobile terminal 100. The wireless communication unit 110 may include a radio frequency transmitter for upconverting the frequency of a signal to be transmitted and for amplifying the signal, and a radio frequency receiver for low-noise amplifying a received signal and for downconverting the frequency of the signal. The wireless communication unit 110 may receive data through a wireless channel and forward the received data to the control unit 170, and may transmit data from the control unit 170 through the wireless channel.

The first touch screen 120 includes a first touch sensor 121 and a first display 122. The first touch sensor 121 recognizes a user's touch, and may be implemented using a capacitive sensor, a resistive sensor, an infrared sensor or a pressure sensor. In an exemplary implementation, any sensor capable of detecting contact or pressure may be utilized as the first touch sensor 121. The first touch sensor 121 generates a touch signal corresponding to a user touch and transmits the touch signal to the control unit 170. The touch signal includes coordinate data of the touch point. When the user makes a touch-point move gesture, the first touch sensor 121 generates a touch signal including coordinate data describing the path of the touch-point move and forwards the generated touch signal to the control unit 170. In an exemplary implementation, a “touch-point move” gesture may correspond to a “flick” action in which a corresponding touch point moves at a speed greater than a preset threshold or to a “drag” action in which the corresponding touch point moves at a speed less than the preset threshold.

The first display 122 may be implemented using Liquid Crystal Display (LCD) devices, Organic Light Emitting Diodes (OLED), or Active Matrix Organic Light Emitting Diodes (AMOLED). The first display 122 visually provides various information such as menus, input data and function-setting data to the user. The first display 122 may output a boot screen, an idle screen, a menu screen, a call handling screen, and other application screens for the mobile terminal 100.

The second touch screen 130 includes a second touch sensor 131 and a second display 132. The second touch sensor 131 may be implemented using the same detecting means as the first touch sensor 121. Similar to the first display 122, the second display 132 may be implemented using LCD devices, OLEDs, or AMOLEDs, and may output an idle screen, a menu screen and other application screens for the mobile terminal 100.

In the following description, it is assumed that the first touch screen 120 is placed above the second touch screen 130 when the folder is open as indicated by reference symbol [b] of FIG. 1.

The audio processing unit 140 may include a coder/decoder (i.e., a codec). The codec includes a data codec for processing packet data, and an audio codec for processing an audio signal such as a voice signal. The audio processing unit 140 converts a digital audio signal into an analog audio signal through the audio codec to reproduce the analog audio signal through a speaker, and also converts an analog audio signal from a microphone into a digital audio signal through the audio codec.

The key input unit 150 generates a key signal corresponding to user manipulation and transmits the key signal to the control unit 170. The key input unit 150 may include a keypad including alphanumeric keys, direction keys and function keys. When the mobile terminal 100 is fully manipulated through the first touch screen 120 and second touch screen 130, the key input unit 150 may be removed from the mobile terminal 100.

The storage unit 160 stores programs and data necessary for the operation of the mobile terminal 100. More particularly, the storage unit 160 stores information on touch gestures made on the first touch screen 120 and the second touch screen 130, and information on screen changes related to the touch gestures. In an exemplary implementation, touch gestures may include a touch action composed of one or more tap operations, and a touch-point move action composed of a touch-and-move operation such as a flick and a drag.

The control unit 170 controls overall operation of the mobile terminal 100. More particularly, the control unit 170 includes a touch screen controller 171. The touch screen controller 171 controls the first touch screen 120 and the second touch screen 130 to display at least one application screen. For example, the touch screen controller 171 may display a single application screen on both the first touch screen 120 and the second touch screen 130, and may display different application screens on the first touch screen 120 and the second touch screen 130. The touch screen controller 171 detects touch gestures made by the user on the first touch screen 120 and the second touch screen 130, identifies a pattern of the touch gestures, and controls the first touch screen 120 and the second touch screen 130 to change at least one application screen according to the touch gesture pattern. For example, an application screen on only the first touch screen 120 may be changed, an application screen on only the second touch screen 130 may be changed, or application screens on both the first touch screen 120 and the second touch screen 130 may be changed.

For identification of a touch gesture pattern, the touch screen controller 171 may determine the directions of touch-point move gestures made on the first touch screen 120 and the second touch screen 130. For example, the touch screen controller 171 may determine that the touch-point move gestures made respectively on the first touch screen 120 and the second touch screen 130 are in the same direction. The touch screen controller 171 may determine that a touch-point move gesture made on the first touch screen 120 is in a direction toward the second touch screen 130 and another touch-point move gesture made on the second touch screen 130 is in a direction toward the first touch screen 120. The touch screen controller 171 may determine that a touch-point move gesture made on the first touch screen 120 is in an opposite direction to the second touch screen 130 and another touch-point move gesture made on the second touch screen 130 is in an opposite direction to the first touch screen 120.

When the touch-point move gestures made respectively on the first touch screen 120 and the second touch screen 130 are in the same direction, the touch screen controller 171 may enlarge a first application screen displayed on the first touch screen 120 so that the first application screen is displayed on both the first touch screen 120 and the second touch screen 130, or may enlarge a second application screen displayed on the second touch screen 130 so that the second application screen is displayed on both the first touch screen 120 and the second touch screen 130.

When the touch-point move gesture made on the first touch screen 120 is in a direction toward the second touch screen 130 and another touch-point move gesture made on the second touch screen 130 is in a direction toward the first touch screen 120, the touch screen controller 171 may perform an application screen exchange so that a first application screen displayed on the first touch screen 120 is displayed on the second touch screen 130 and a second application screen displayed on the second touch screen 130 is displayed on the first touch screen 120.

When a touch-point move gesture made on the first touch screen 120 is in an opposite direction to the second touch screen 130 and another touch-point move gesture made on the second touch screen 130 is in an opposite direction to the first touch screen 120, the touch screen controller 171 may display idle screens respectively on the first touch screen 120 and the second touch screen 130.

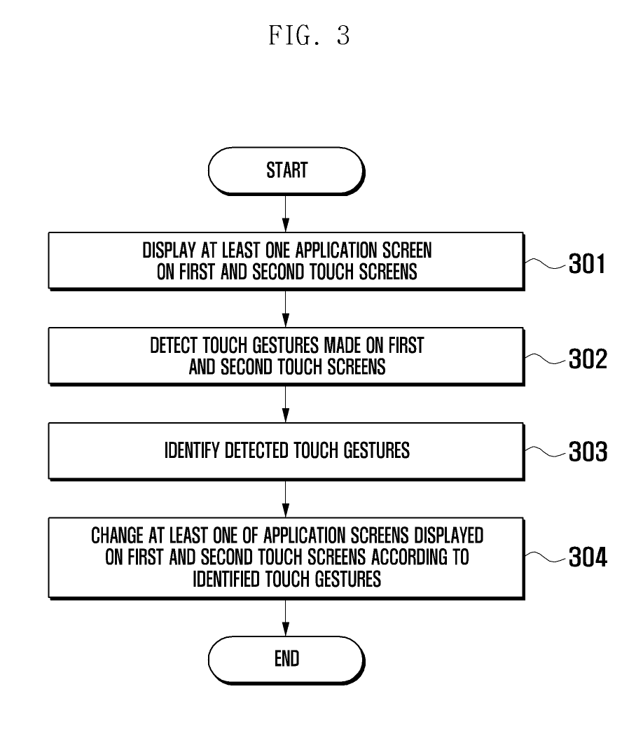

FIG. 3 is a flowchart illustrating a screen control method for a mobile terminal including multiple touch screens according to an exemplary embodiment of the present invention.

Referring to FIG. 3, the touch screen controller 171 controls the first touch screen 120 and the second touch screen 130 to display one or more application screens in step 301. An “application” refers to an executable program controlling a function supported by the mobile terminal 100. For example, applications may be associated with functions for music playback, moving image playback, photography, web browsing, idle screen display, menu display, and the like. Application screens may include a music playback screen, a moving image playback screen, a web browsing screen, a message composition screen, an idle screen, a menu screen, and the like.

The touch screen controller 171 may display a single application screen on both the first touch screen 120 and the second touch screen 130, or may display different application screens on the first touch screen 120 and the second touch screen 130.

The touch screen controller 171 controls the first touch screen 120 and the second touch screen 130 to detect touch gestures made by the user in step 302. In an exemplary implementation, it is assumed that the user makes a touch-point move gesture on the first touch screen 120 or the second touch screen 130 by touching and moving the touch point while maintaining contact. It is also assumed that the user makes touch gestures simultaneously on the first touch screen 120 and the second touch screen 130 at the same time. A threshold time for determining simultaneity of touch gestures is stored in the storage unit 160. When the user makes a touch gesture on the second touch screen 130 within the threshold time after making a touch gesture on the first touch screen 120 or the user makes a touch gesture on the first touch screen 120 within the threshold time after making a touch gesture on the second touch screen 130, the touch screen controller 171 considers the two touch gestures as gestures occurring simultaneously on the first touch screen 120 and the second touch screen 130. Each of the first touch screen 120 and the second touch screen 130 generates a detecting signal corresponding to a touch gesture made by the user and transmits the detecting signal to the touch screen controller 171. Here, the detecting signal includes coordinate data of the touch point. When the user makes a touch-point move gesture after a touch, each of the first touch screen 120 and the second touch screen 130 generates a detecting signal including coordinate data describing a path of the touch-point move and forwards the generated detecting signal to the touch screen controller 171. The touch screen controller 171 receives detecting signals from the first touch screen 120 and the second touch screen 130 and obtains touch coordinates included in the detecting signals.

The touch screen controller 171 identifies a pattern of touch gestures in step 303. When the user makes touch-point move gestures while sustaining contact after touching the first touch screen 120 and the second touch screen 130, the touch screen controller 171 receives detecting signals from the first touch screen 120 and the second touch screen 130, obtains coordinate data describing the paths of the touch-point moves included in the detecting signals, and identifies the pattern of touch gesture based on the obtained coordinate data. The storage unit 160 stores information regarding touch gestures, and the touch screen controller 171 uses this information to identify the gesture made by the user.

For identification of a touch gesture, the touch screen controller 171 may determine the directions of the touch-point move gestures made on the first touch screen 120 and the second touch screen 130. For example, the touch screen controller 171 may determine that the touch-point move gestures made respectively on the first touch screen 120 and the second touch screen 130 are in the same direction. More specifically, the touch-point move gestures made on the first touch screen 120 and the second touch screen 130 may be an upward touch-point move gesture or a downward touch-point move gesture.

The touch screen controller 171 may determine that a touch-point move gesture made on the first touch screen 120 is in a direction toward the second touch screen 130 and another touch-point move gesture made on the second touch screen 130 is in a direction toward the first touch screen 120. More specifically, assuming that the first touch screen 120 is placed above the second touch screen 130 as indicated by reference symbol [b] of FIG. 1, a downward touch-point move gesture may be input to the first touch screen 120 and an upward touch-point move gesture may be input to the second touch screen 130.

The touch screen controller 171 may determine that a touch-point move gesture made on the first touch screen 120 is in an opposite direction to the second touch screen 130 and another touch-point move gesture made on the second touch screen 130 is in an opposite direction to the first touch screen 120. More specifically, assuming that the first touch screen 120 is placed above the second touch screen 130 as indicated by reference symbol [b] of FIG. 1, an upward touch-point move gesture may be input to the first touch screen 120 and a downward touch-point move gesture may be input to the second touch screen 130.

The touch screen controller 171 controls the first touch screen 120 and the second touch screen 130 to change at least one of the displayed application screens according to the identified touch gesture pattern in step 304. That is, an application screen on only the first touch screen 120 may be changed, an application screen on only the second touch screen 130 may be changed, or application screens on both the first touch screen 120 and the second touch screen 130 may be changed.

More specifically, when the touch-point move gestures made respectively on the first touch screen 120 and the second touch screen 130 are in the same direction, the touch screen controller 171 may enlarge a first application screen displayed on the first touch screen 120 so that the first application screen is displayed on both the first touch screen 120 and the second touch screen 130, or may enlarge a second application screen displayed on the second touch screen 130 so that the second application screen is displayed on both the first touch screen 120 and the second touch screen 130.

When a touch-point move gesture made on the first touch screen 120 is in a direction toward the second touch screen 130 and another touch-point move gesture made on the second touch screen 130 is in a direction toward the first touch screen 120, the touch screen controller 171 may perform application screen exchange so that a first application screen displayed on the first touch screen 120 is displayed on the second touch screen 130 and a second application screen displayed on the second touch screen 130 is displayed on the first touch screen 120.

When a touch-point move gesture made on the first touch screen 120 is in an opposite direction to the second touch screen 130 and another touch-point move gesture made on the second touch screen 130 is in an opposite direction to the first touch screen 120, the touch screen controller 171 may display idle screens respectively on the first touch screen 120 and the second touch screen 130.

A screen control method of the first touch screen and the second touch screen of the mobile terminal will be described below.

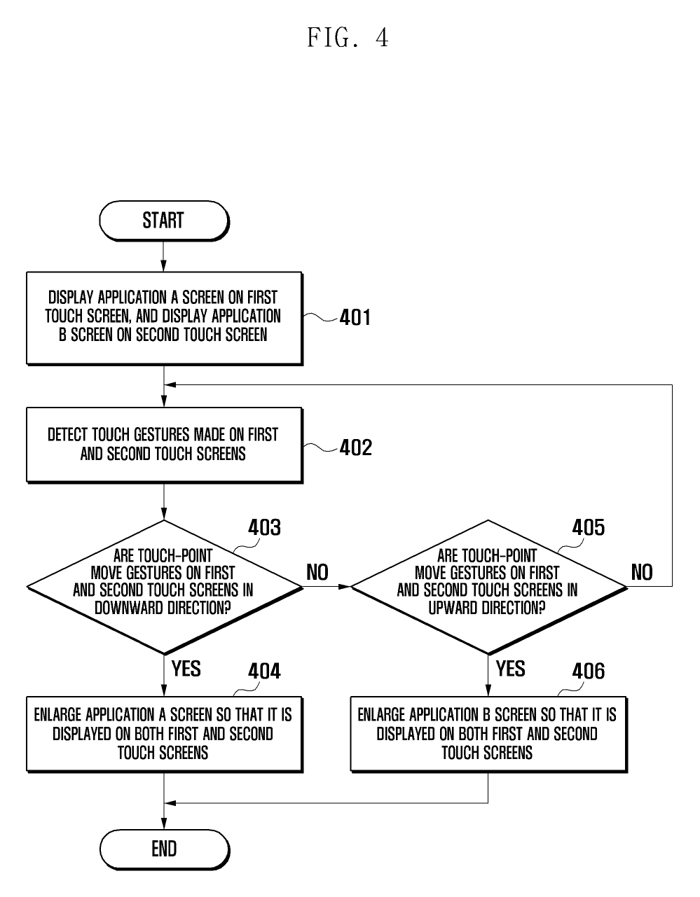

FIG. 4 is a flowchart illustrating a screen control method for a mobile terminal including multiple touch screens according to an exemplary embodiment of the present invention.

Referring to FIG. 4, the touch screen controller 171 controls the first touch screen 120 to display an application A screen, and controls the second touch screen 130 to display an application B screen in step 401. The application A screen and the application B screen may correspond to one of a music playback screen, a moving image playback screen, a web browsing screen, a message composition screen, an idle screen, a menu screen, and the like. The user may execute the application A and the application B concurrently, and direct the touch screen controller 171 to display the application A screen and the application B screen respectively on the first touch screen 120 and the second touch screen 130.

The touch screen controller 171 controls the first touch screen 120 and the second touch screen 130 to detect touch gestures made by a user in step 402. Each of the first touch screen 120 and the second touch screen 130 generates a detecting signal corresponding to a touch gesture made by the user and transmits the detecting signal including coordinate data of the touch point to the touch screen controller 171. Upon reception of the detecting signal, the touch screen controller 171 obtains coordinate data of the touch point included in the detecting signal. In an exemplary implementation, it is assumed that the user makes touch-point move gestures in the same direction, for example, either an upwards direction or a downwards direction, while sustaining contact after touching the first touch screen 120 and the second touch screen 130.

The touch screen controller 171 identifies a pattern of touch gestures based on the obtained coordinate data, and determines whether the touch-point move gestures made on the first touch screen 120 and the second touch screen 130 are both in the downward direction in step 403. If it is determined that the touch-point move gestures made on the first touch screen 120 and the second touch screen 130 are both in the downward direction, the touch screen controller 171 enlarges the application A screen displayed on the first touch screen 120 so that the application A screen is displayed on both the first touch screen 120 and the second touch screen 130 in step 404. Here, on the second touch screen 130, the application A screen is placed above the application B screen. The control unit 170 may run the application A and the application B in the foreground and in the background, respectively.

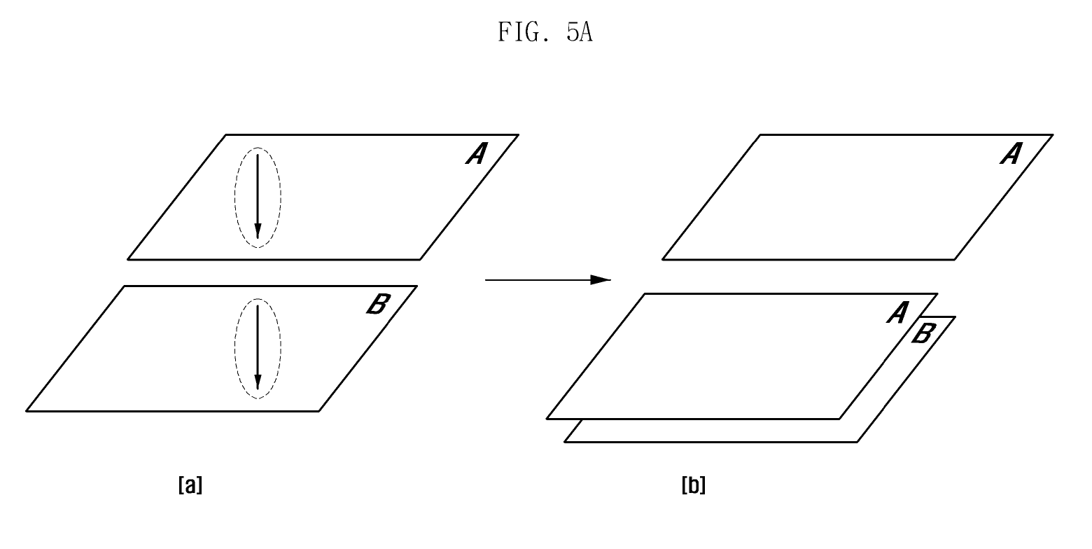

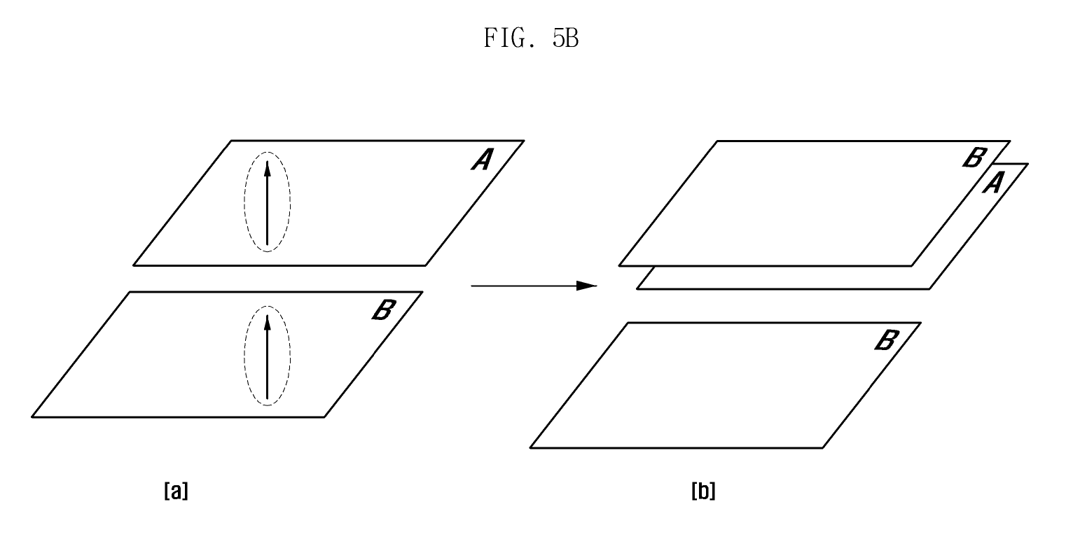

FIG. 5A depicts a screen display change on a first touch screen and a second touch screen in response to downward touch-point move gestures according to an exemplary embodiment of the present invention.

Referring to FIG. 5A, reference symbol [a] depicts a situation in which a user makes downward touch-point move gestures respectively on the first touch screen 120 and the second touch screen 130 while the application A screen is displayed on the first touch screen 120 and the application B screen is displayed on the second touch screen 130. Reference symbol [b] of FIG. 5A depicts a screen display change after making the downward touch-point move gestures, in response to which the application A screen is displayed on both the first touch screen 120 and the second touch screen 130. On the second touch screen 130, the application B screen is placed below the application A screen.

Referring back to FIG. 4, when the touch-point move gestures made on the first touch screen 120 and the second touch screen 130 are both not in the downward direction in step 403, the touch screen controller 171 determines whether the touch-point move gestures made on the first touch screen 120 and the second touch screen 130 are both in the upward direction in step 405. If it is determined that the touch-point move gestures made on the first touch screen 120 and the second touch screen 130 are both in the upward direction, the touch screen controller 171 enlarges the application B screen displayed on the second touch screen 130 so that the application B screen is displayed on both the first touch screen 120 and the second touch screen 130 in step 406. Here, on the first touch screen 120, the application B screen is placed above the application A screen. The control unit 170 may run the application B and the application A in the foreground and in the background, respectively.

FIG. 5B depicts a screen display change on a first touch screen and a second touch screen in response to upward touch-point move gestures according to an exemplary embodiment of the present invention.

Referring to FIG. 5B, reference symbol [a] depicts a situation in which the user makes upward touch-point move gestures respectively on the first touch screen 120 and the second touch screen 130 while the application A screen is displayed on the first touch screen 120 and the application B screen is displayed on the second touch screen 130. Reference symbol [b] of FIG. 5B depicts a screen display change after making the upward touch-point move gestures, in response to which the application B screen is displayed on both the first touch screen 120 and the second touch screen 130. On the first touch screen 130, the application A screen is placed below the application B screen.

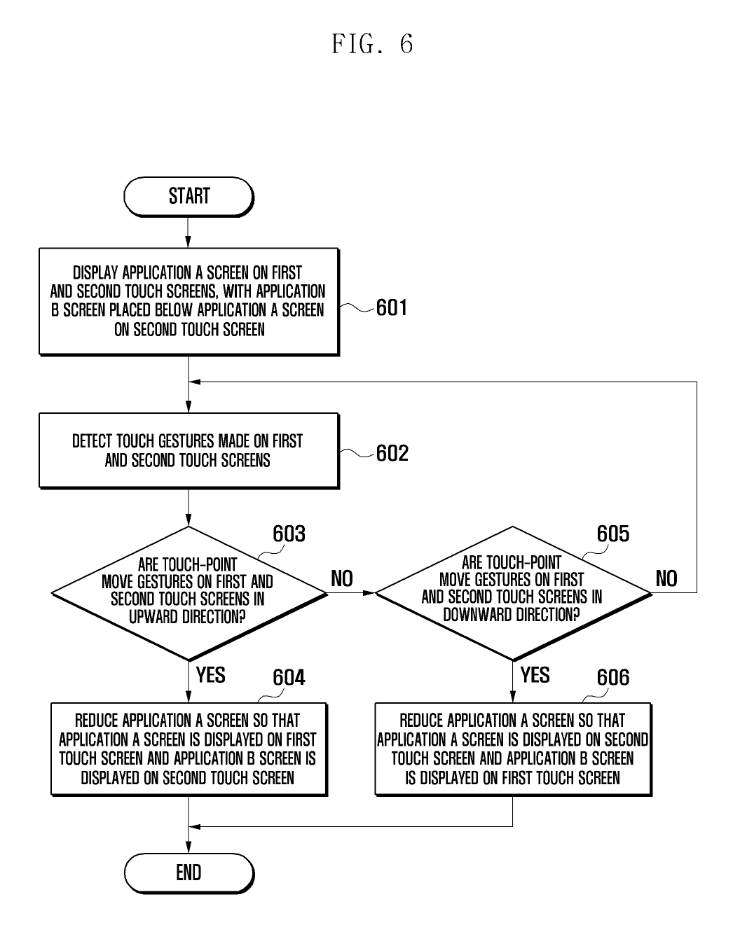

FIG. 6 is a flowchart illustrating a screen control method for a mobile terminal including multiple touch screens according to an exemplary embodiment of the present invention.

Referring to FIG. 6, the touch screen controller 171 controls the first touch screen 120 to display an application A screen above an application B screen, and controls the second touch screen 130 to display the application A screen in step 601. Here, the control unit 170 may run the application A in the foreground using the first touch screen 120 and the second touch screen 130, and run the application B in the background using the first touch screen 120. Alternatively, the touch screen controller 171 may control the first touch screen 120 to display an application A screen, and control the second touch screen 130 to display the application A screen above an application B screen.

The touch screen controller 171 controls the first touch screen 120 and the second touch screen 130 to detect touch gestures made by a user in step 602. Each of the first touch screen 120 and the second touch screen 130 generates a detecting signal corresponding to a touch gesture made by the user and transmits the detecting signal including coordinate data of the touch point to the touch screen controller 171. Upon reception of the detecting signal, the touch screen controller 171 obtains coordinate data of the touch point included in the detecting signal. In an exemplary implementation, it is assumed that the user makes touch-point move gestures in the same direction, for example, either an upwards direction or a downwards direction, while sustaining contact after touching the first touch screen 120 and the second touch screen 130.

The touch screen controller 171 identifies a pattern of touch gestures based on the obtained coordinate data, and determines whether the touch-point move gestures made on the first touch screen 120 and the second touch screen 130 are both in the upward direction in step 603. If it is determined that the touch-point move gestures made on the first touch screen 120 and the second touch screen 130 are both in the upward direction, the touch screen controller 171 reduces the application A screen and moves the application B screen placed below the application A screen so that the application A screen is displayed on the first touch screen 120 and the application B screen is displayed on the second touch screen 130 in step 604. Alternatively, in response to entering upward touch-point move gestures while the application A screen is displayed on both the first touch screen 120 and the second touch screen 130 and the application B screen is placed below the application A screen on the second touch screen 130, the touch screen controller 171 may reduce the application A screen so that the application A screen is displayed on the first touch screen 120 and the application B screen is displayed on the second touch screen 130.

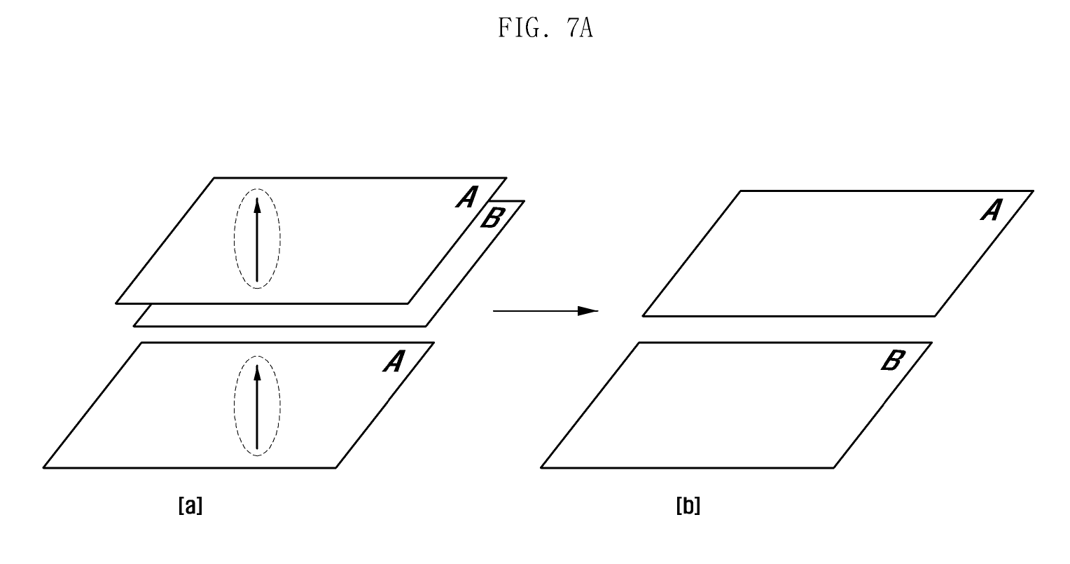

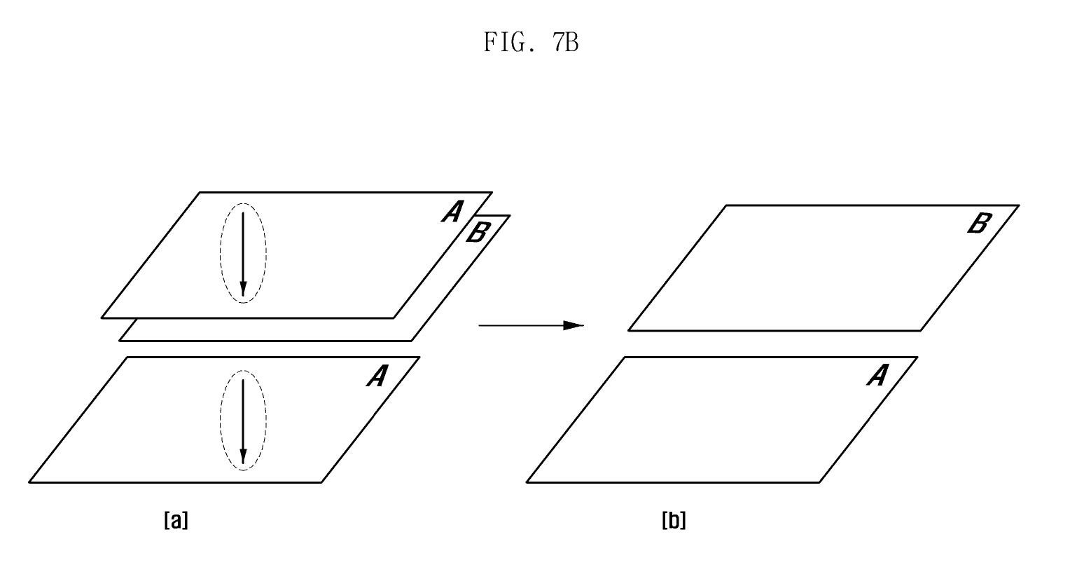

FIG. 7A depicts a screen display change on a first touch screen and a second touch screen in response to upward touch-point move gestures according to an exemplary embodiment of the present invention.

Referring to FIG. 7A, reference symbol [a] depicts a situation in which a user makes upward touch-point move gestures respectively on the first touch screen 120 and the second touch screen 130 while the application A screen is displayed on the first touch screen 120 and the second touch screen 130 and the application B screen is placed below the application A screen on the first touch screen 120. Reference symbol [b] of FIG. 7A depicts a screen display change after making the upward touch-point move gestures, in response to which the application A screen is displayed on the first touch screen 120 and the application B screen is displayed on the second touch screen 130.

Referring back to FIG. 6, when the touch-point move gestures made on the first touch screen 120 and the second touch screen 130 are both not in the upward direction in step 603, the touch screen controller 171 determines whether the touch-point move gestures made on the first touch screen 120 and the second touch screen 130 are both in the downward direction in step 605. If it is determined that the touch-point move gestures made on the first touch screen 120 and the second touch screen 130 are both in the downward direction, the touch screen controller 171 reduces the application A screen so that the application B screen is displayed on the first touch screen 120 and the application A screen is displayed on the second touch screen 130 in step 606. Alternatively, in response to a downward touch-point move gestures while the application A screen is displayed on both the first touch screen 120 and the second touch screen 130 and the application B screen is placed below the application A screen on the second touch screen 130, the touch screen controller 171 may reduce the application A screen and move the application B screen so that the application A screen is displayed on the second touch screen 130 and the application B screen is displayed on the first touch screen 120.

FIG. 7B depicts a screen display change on the first touch screen and second touch screen in response to downward touch-point move gestures according to an exemplary embodiment of the present invention.

Referring to FIG. 7B, reference symbol [a] of FIG. 7B depicts a situation in which a user makes downward touch-point move gestures respectively on the first touch screen 120 and the second touch screen 130 while the application A screen is displayed on the first touch screen 120 and second touch screen 130 and the application B screen is placed below the application A screen on the first touch screen 120. Reference symbol [b] of FIG. 7B depicts a screen display change after making the downward touch-point move gestures, in response to which the application A screen is displayed on the second touch screen 130 and the application B screen is displayed on the first touch screen 120.

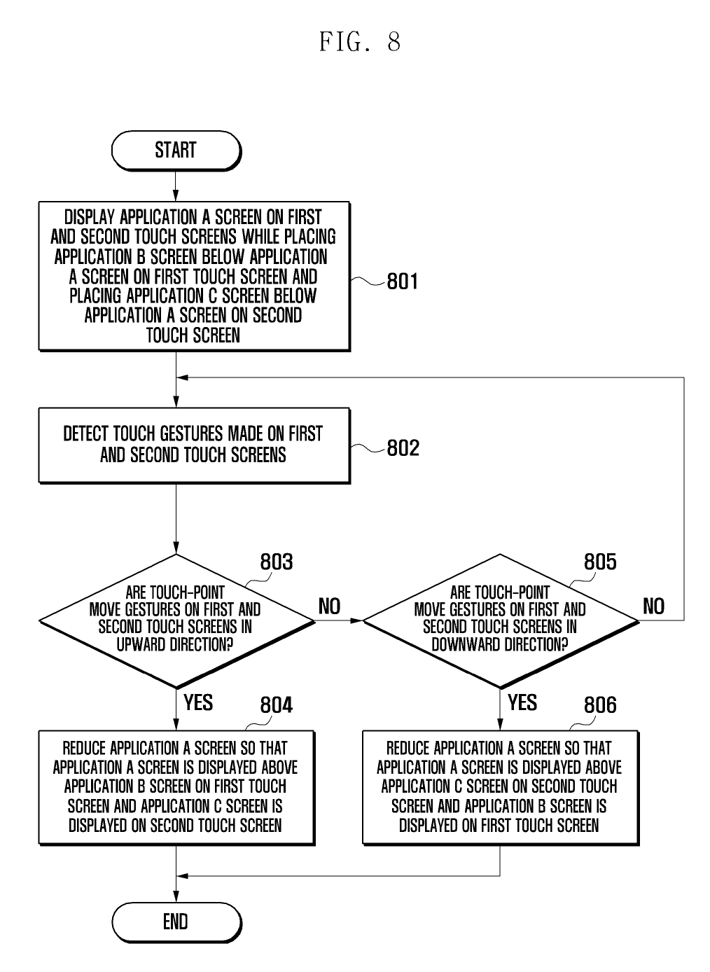

FIG. 8 is a flowchart illustrating a screen control method for a mobile terminal including multiple touch screens according to an exemplary embodiment of the present invention.

Referring to FIG. 8, the touch screen controller 171 controls the first touch screen 120 to display an application A screen above an application B screen, and controls the second touch screen 130 to display the application A screen above an application C screen in step 801. Here, the control unit 170 may run the application A in the foreground using the first touch screen 120 and the second touch screen 130, run the application B in the background using the first touch screen 120, and run the application C in the background using the second touch screen 130.

The touch screen controller 171 controls the first touch screen 120 and the second touch screen 130 to detect touch gestures made by a user in step 802. Each of the first touch screen 120 and the second touch screen 130 generates a detecting signal corresponding to a touch gesture made by the user and transmits the detecting signal including coordinate data of the touch point to the touch screen controller 171. Upon reception of the detecting signal, the touch screen controller 171 obtains coordinate data of the touch point included in the detecting signal. In an exemplary implementation, it is assumed that the user makes touch-point move gestures in the same direction, for example, either an upwards direction or a downwards direction, while sustaining contact after touching the first touch screen 120 and the second touch screen 130.

The touch screen controller 171 identifies the pattern of touch gestures based on the obtained coordinate data, and determines whether the touch-point move gestures made on the first touch screen 120 and the second touch screen 130 are both in the upward direction in step 803. If it is determined that the touch-point move gestures made on the first touch screen 120 and the second touch screen 130 are both in the upward direction, the touch screen controller 171 reduces the application A screen so that the application A screen is displayed on the first touch screen 120 and the application C screen below the application A screen is displayed on the second touch screen 130 in step 804. Here, the control unit 170 may place the application C in the foreground on the second touch screen 130.

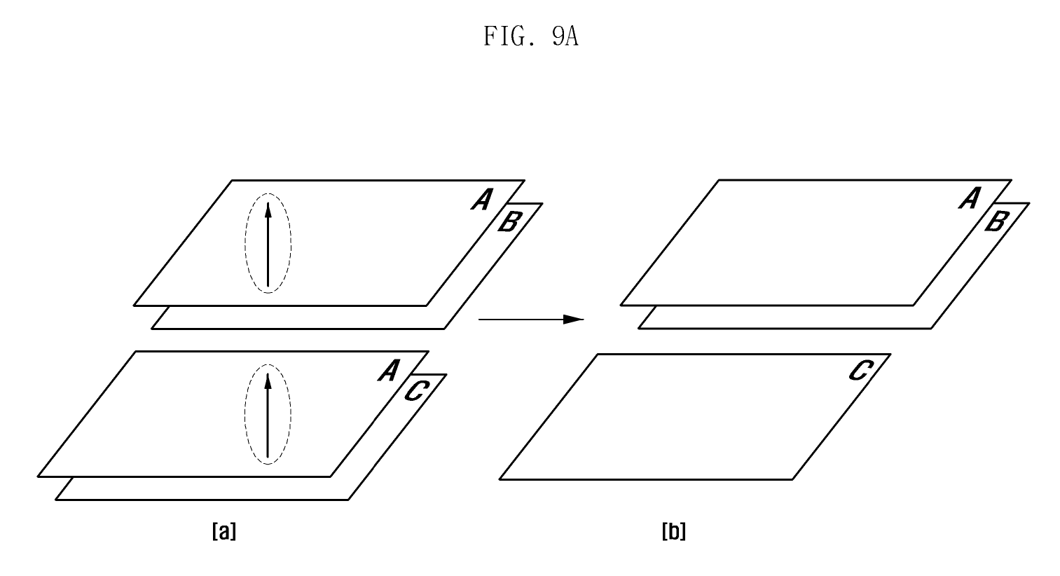

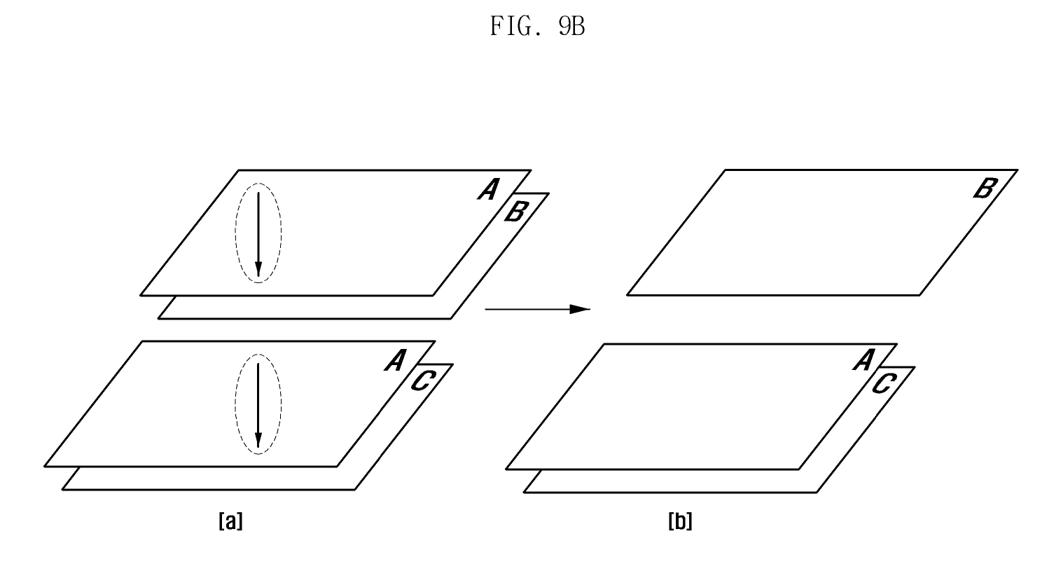

FIG. 9A depicts a screen display change on a first touch screen and a second touch screen in response to upward touch-point move gestures according to an exemplary embodiment of the present invention.

Referring to FIG. 9A, reference symbol [a] depicts a situation in which a user makes upward touch-point move gestures respectively on the first touch screen 120 and the second touch screen 130 while the first touch screen 120 displays the application A screen above the application B screen and the second touch screen 130 displays the application A screen above the application C screen. Reference symbol [b] of FIG. 9A depicts a screen display change after making the upward touch-point move gestures, in response to which the application A screen is reduced and displayed on the first touch screen 120 and the application C screen is displayed on the second touch screen 130.

Referring back to FIG. 8, when the touch-point move gestures made on the first touch screen 120 and the second touch screen 130 are both not in the upward direction in step 803, the touch screen controller 171 determines whether the touch-point move gestures made on the first touch screen 120 and the second touch screen 130 are both in the downward direction in step 805. If it is determined that the touch-point move gestures made on the first touch screen 120 and the second touch screen 130 are both in the downward direction, the touch screen controller 171 reduces the application A screen so that the application B screen is displayed on the first touch screen 120 and the application A screen is displayed on the second touch screen 130 in step 806.

FIG. 9B depicts a screen display change on a first touch screen and a second touch screen in response to downward touch-point move gestures according to an exemplary embodiment of the present invention.

Referring to FIG. 9B, reference symbol [a] of FIG. 9B depicts a situation in which a user makes downward touch-point move gestures respectively on the first touch screen 120 and the second touch screen 130 while the first touch screen 120 displays the application A screen above the application B screen and the second touch screen 130 displays the application A screen above an application C screen. Reference symbol [b] of FIG. 9B depicts a screen display change after making the downward touch-point move gestures, in response to which the application A screen is displayed on the second touch screen 130 and the application B screen is displayed on the first touch screen 120.

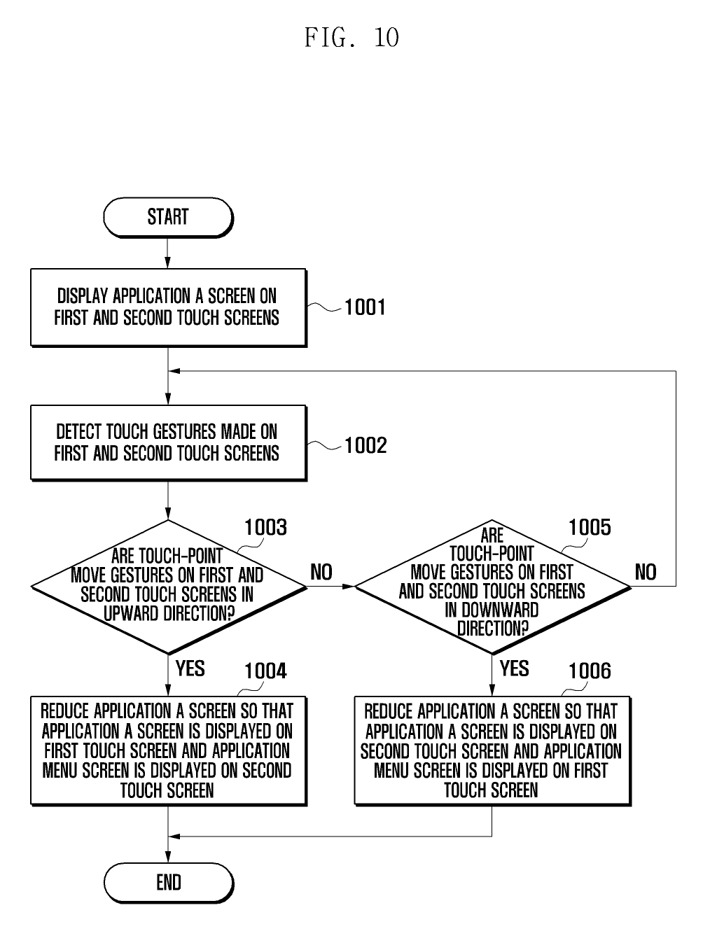

FIG. 10 is a flowchart illustrating a screen control method for a mobile terminal including multiple touch screens according to an exemplary embodiment of the present invention.

Referring to FIG. 10, the touch screen controller 171 controls the first touch screen 120 and the second touch screen 130 to display an application A screen in step 1001. In an exemplary implementation, no application screen is below the application A screen on the first touch screen 120 and the second touch screen 130. Here, “application” screens do not include default screens, for example, an idle screen and a menu screen, provided in the mobile terminal 100 and may include screens (e.g., a music playback screen, a moving image playback screen, a web browsing screen, a message composition screen, and the like) related to applications explicitly run by the user.

The touch screen controller 171 controls the first touch screen 120 and the second touch screen 130 to detect touch gestures made by the user in step 1002. Each of the first touch screen 120 and the second touch screen 130 generates a detecting signal corresponding to a touch gesture made by the user and transmits the detecting signal including coordinate data of the touch point to the touch screen controller 171. Upon reception of the detecting signal, the touch screen controller 171 obtains coordinate data of the touch point included in the detecting signal. In an exemplary implementation, it is assumed that the user makes touch-point move gestures in the same direction, for example, either an upwards direction or a downwards direction, while sustaining contact after touching the first touch screen 120 and the second touch screen 130.

The touch screen controller 171 identifies the pattern of touch gestures based on the obtained coordinate data, and determines whether the touch-point move gestures made on the first touch screen 120 and the second touch screen 130 are both in the upward direction in step 1003. If it is determined that the touch-point move gestures made on the first touch screen 120 and the second touch screen 130 are both in the upward direction, the touch screen controller 171 reduces the application A screen so that the application A screen is displayed on the first touch screen 120 and an application menu screen is displayed on the second touch screen 130 in step 1004. Here, the application menu screen refers to any default menu screen such as the main menu screen or a user settable menu screen set in the mobile terminal 100. As described above, on the second touch screen 130, no application screen is placed below the application A screen. When the application A screen reduces onto the first touch screen 120, no application screen is displayed on the second touch screen 130. In this case, the touch screen controller 171 displays the application menu screen on the second touch screen 130 to enable the user to run a desired application on the second touch screen 130. When the user selects an application on the application menu screen, the touch screen controller 171 displays a screen related to the selected application on the second touch screen 130.

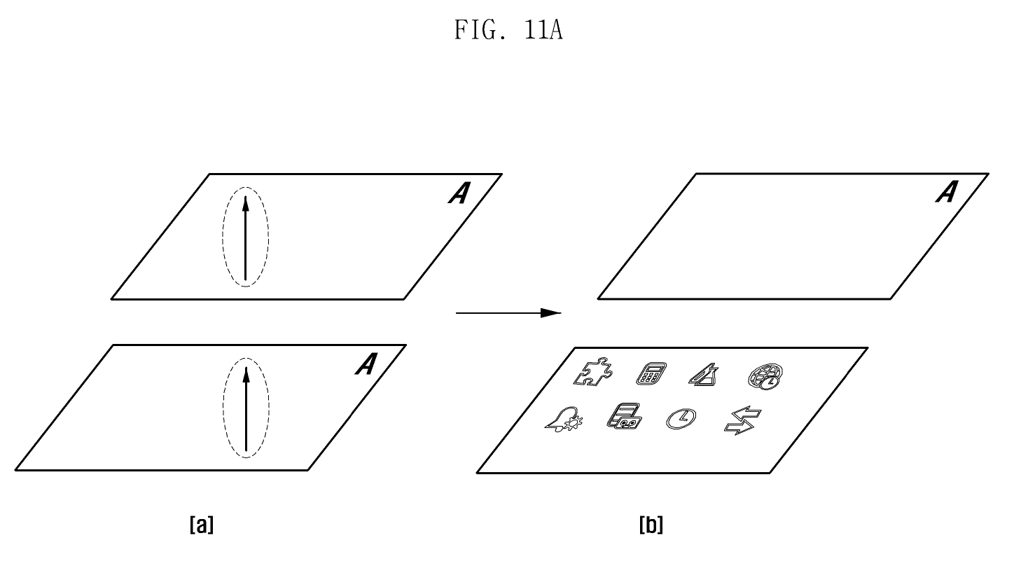

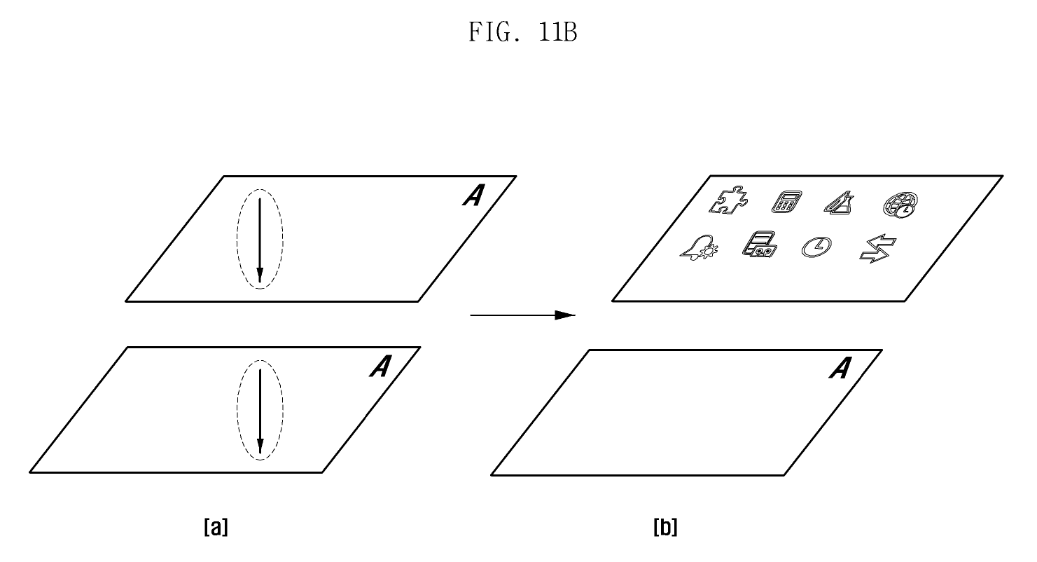

FIG. 11A depicts a screen display change on a first touch screen and a second touch screen in response to upward touch-point move gestures according to an exemplary embodiment of the present invention.

Referring to FIG. 11A, reference symbol [a] depicts a situation in which the user makes upward touch-point move gestures respectively on the first touch screen 120 and the second touch screen 130 while both the first touch screen 120 and the second touch screen 130 display the application A screen. Reference symbol [b] of FIG. 11A depicts a screen display change after making the upward touch-point move gestures, in response to which the application A screen is reduced and displayed on the first touch screen 120 and the application menu screen is displayed on the second touch screen 130.

Referring back to FIG. 10, when the touch-point move gestures made on the first touch screen 120 and the second touch screen 130 are both not in the upward direction in step 1003, the touch screen controller 171 determines whether the touch-point move gestures made on the first touch screen 120 and the second touch screen 130 are both in the downward direction in step 1005. If it is determined that the touch-point move gestures made on the first touch screen 120 and the second touch screen 130 are both in the downward direction, the touch screen controller 171 reduces the application A screen so that the application A screen is displayed on the second touch screen 130 and the application menu screen is displayed on the first touch screen 120 in step 1006.

FIG. 11B depicts a screen display change on a first touch screen and second touch screen in response to downward touch-point move gestures according to an exemplary embodiment of the present invention.

Referring to FIG. 11B, reference symbol [a] depicts a situation in which a user makes downward touch-point move gestures respectively on the first touch screen 120 and the second touch screen 130 while both the first touch screen 120 and the second touch screen 130 display the application A screen. Reference symbol [b] of FIG. 11B depicts a screen display change after making the downward touch-point move gestures, in response to which the application menu screen is displayed on the first touch screen 120 and the application A screen is displayed on the second touch screen 130.

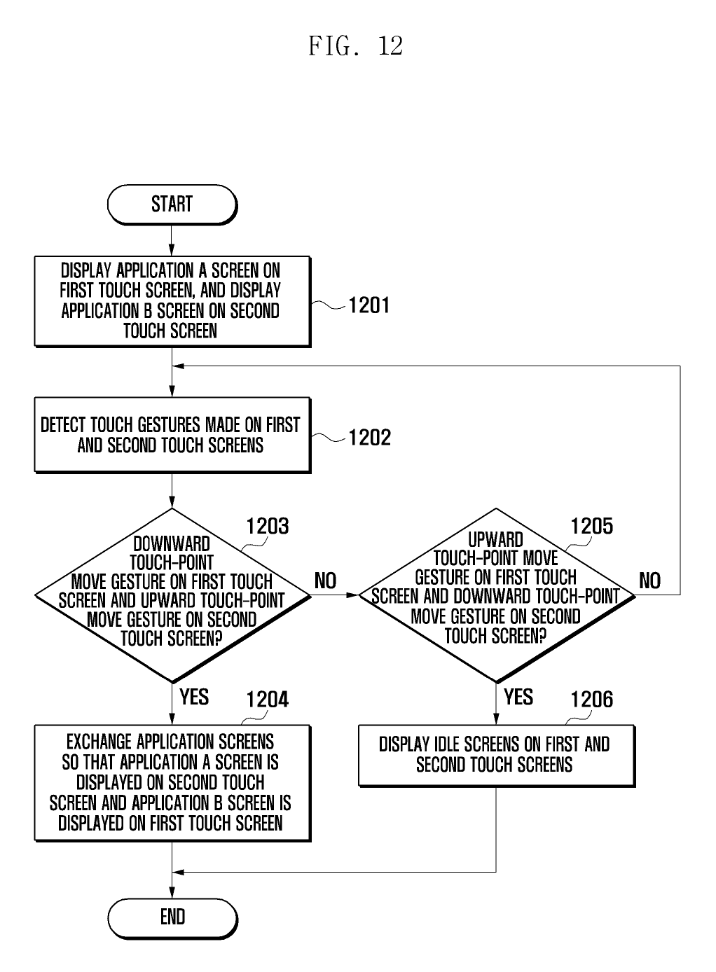

FIG. 12 is a flowchart illustrating a screen control method for a mobile terminal including multiple touch screens according to an exemplary embodiment of the present invention.

Referring to FIG. 12, the touch screen controller 171 controls the first touch screen 120 to display an application A screen, and controls the second touch screen 130 to display an application B screen in step 1201.

The touch screen controller 171 controls the first touch screen 120 and the second touch screen 130 to detect touch gestures made by a user in step 1202. Each of the first touch screen 120 and the second touch screen 130 generates a detecting signal corresponding to a touch gesture made by a user and transmits the detecting signal including coordinate data of the touch point to the touch screen controller 171. Upon reception of the detecting signal, the touch screen controller 171 obtains coordinate data of the touch point included in the detecting signal. In an exemplary implementation, it is assumed that the user makes touch-point move gestures in the opposite direction for example, either a downwards direction on the first touch screen 120 and an upwards on the second touch screen 130, or an upwards direction on the first touch screen 120 and a downwards direction on the second touch screen 130, while sustaining contact after touching the first touch screen 120 and the second touch screen 130.

The touch screen controller 171 identifies the pattern of touch gestures based on the obtained coordinate data, and determines whether the touch-point move gesture made on the first touch screen 120 is in the downward direction and the touch-point move gesture made on the second touch screen 130 is in the upward direction in step 1203. If it is determined that the touch-point move gesture made on the first touch screen 120 is in the downward direction and the touch-point move gesture made on the second touch screen 130 is in the upward direction, the touch screen controller 171 switches the locations of the application A screen and the application B screen so that the application A screen is displayed on the second touch screen 130 and the application B screen is displayed on the first touch screen 120 in step 1204.

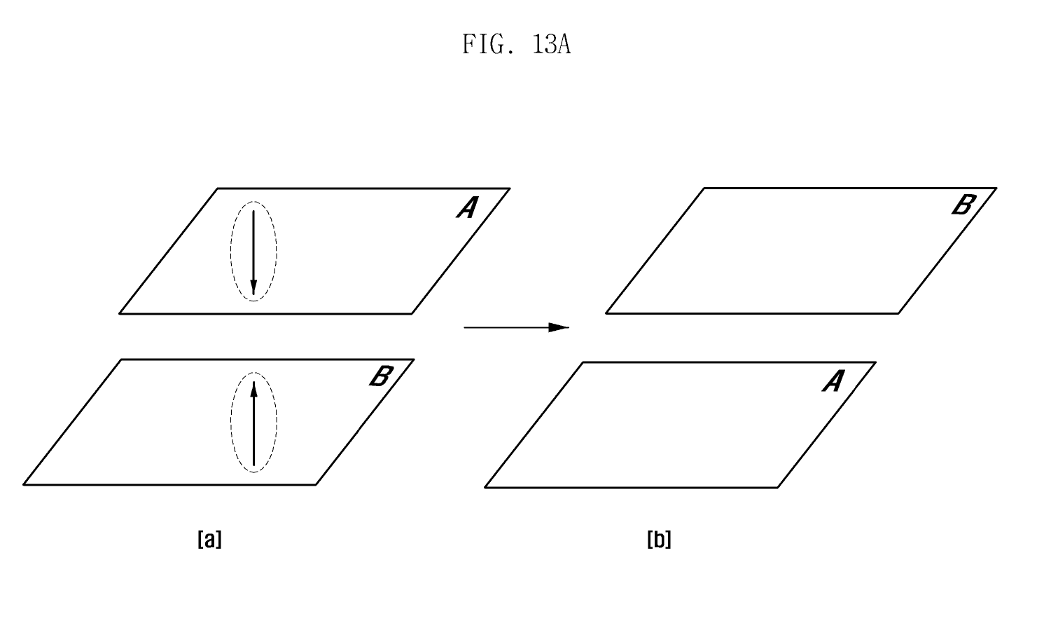

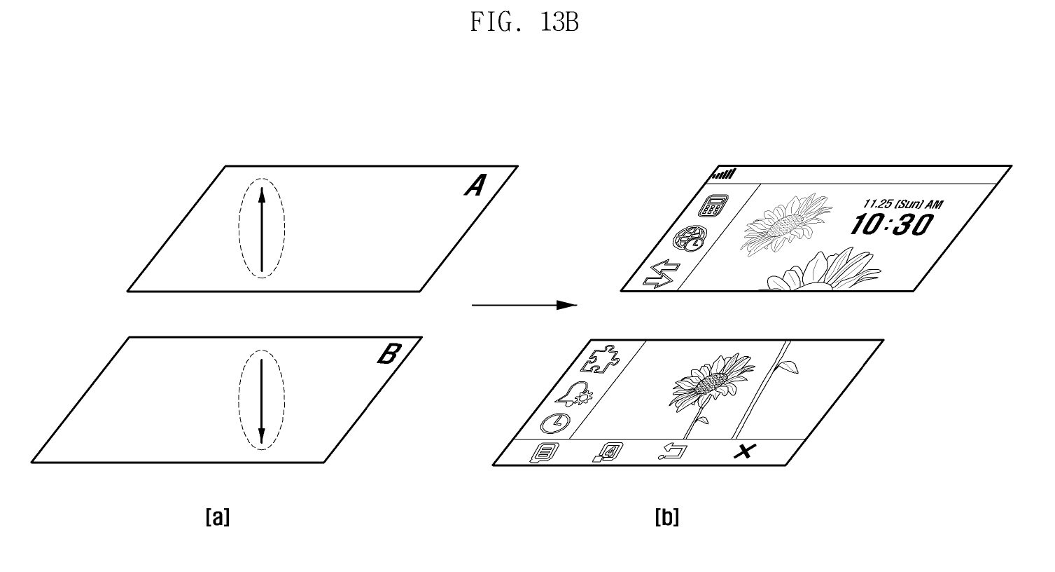

FIG. 13A depicts a screen display change on a first touch screen and a second touch screen in response to a downward touch-point move gesture made on the first touch screen 120 and an upward touch-point move gesture made on the second touch screen 130 according to an exemplary embodiment of the present invention.

Referring to FIG. 13A, reference symbol [a] depicts a situation in which the user makes a downward touch-point move gesture on the first touch screen 120 and makes an upward touch-point move gesture on the second touch screen 130 while the first touch screen 120 displays the application A screen and the second touch screen 130 displays the application B screen. Reference symbol [b] of FIG. 13A depicts a screen display change after making the downward and upward touch-point move gestures, in response to which the application A screen is displayed on the second touch screen 130 and the application B screen is displayed on the first touch screen 120.

Referring back to FIG. 12, when the touch-point move gesture made on the first touch screen 120 is not in the downward direction or the touch-point move gesture made on the second touch screen 130 is not in the upward direction in step 1203, the touch screen controller 171 determines whether the touch-point move gesture made on the first touch screen 120 is in the upward direction and the touch-point move gesture made on the second touch screen 130 is in the downward direction in step 1205. If it is determined that the touch-point move gesture made on the first touch screen 120 is in the upward direction and the touch-point move gesture made on the second touch screen 130 is in the downward direction, the touch screen controller 171 displays idle screens on the first touch screen 120 and the second touch screen 130 in step 1206. Here, the idle screen refers to a widget screen or a home screen. In response to the upward touch-point move gesture made on the first touch screen 120 and the downward touch-point move gesture made on the second touch screen 130, the control unit 170 may terminate execution of the application A and the application B and enter the idle state, and the touch screen controller 171 displays idle screens on the first touch screen 120 and the second touch screen 130.

FIG. 13B depicts a screen display change on a first touch screen and a second touch screen in response to an upward touch-point move gesture made on the first touch screen and a downward touch-point move gesture made on the second touch screen according to an exemplary embodiment of the present invention.

Referring to FIG. 13B, reference symbol [a] depicts a situation in which a user makes an upward touch-point move gesture on the first touch screen 120 and makes a downward touch-point move gesture on the second touch screen 130 while the first touch screen 120 displays the application A screen and the second touch screen 130 displays the application B screen. Reference symbol [b] of FIG. 13B depicts a screen display change after making the upward and downward touch-point move gestures, in response to which idle screens are displayed on the first touch screen 120 and the second touch screen 130.

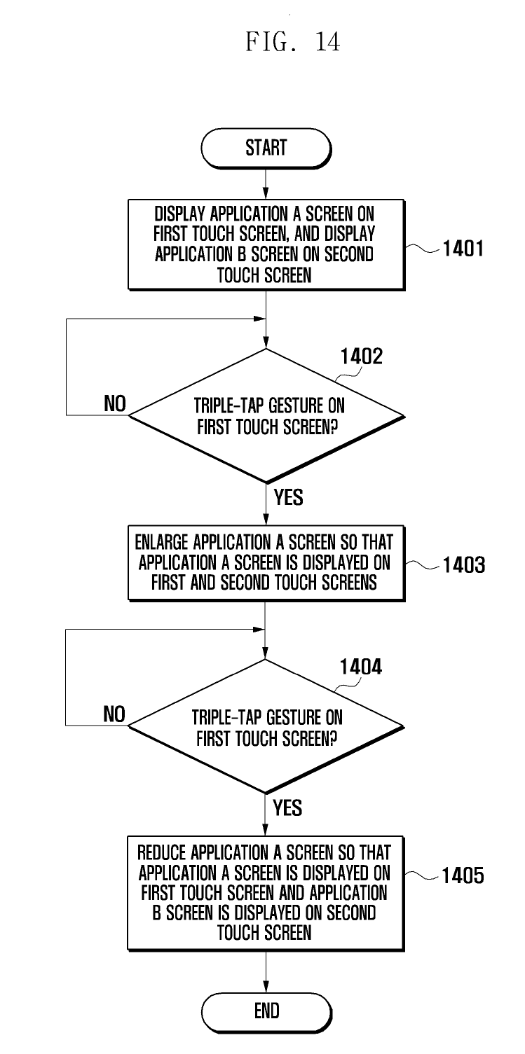

FIG. 14 is a flowchart illustrating a screen control method for a mobile terminal including multiple touch screens according to an exemplary embodiment of the present invention.

In an exemplary implementation, touch gestures are made on one of the first touch screen 120 and the second touch screen 130.

Referring to FIG. 14, the touch screen controller 171 controls a first touch screen 120 to display an application A screen above, and controls the second touch screen 130 to display the application B screen in step 1401.

The touch screen controller 171 determines whether a triple-tap gesture is made on the first touch screen 120 in step 1402. Alternatively, the touch screen controller 171 may determine whether a triple-tap gesture is made on the second touch screen 130, or determine whether more than one tap is entered on the first touch screen 120 or the second touch screen 130.

If it is determined that a triple-tap gesture is made on the first touch screen 120, the touch screen controller 171 enlarges the application A screen so that the application A screen is displayed on both the first touch screen 120 and the second touch screen 130 in step 1403. Here, on the second touch screen 130, the application B screen is placed below the application A screen.

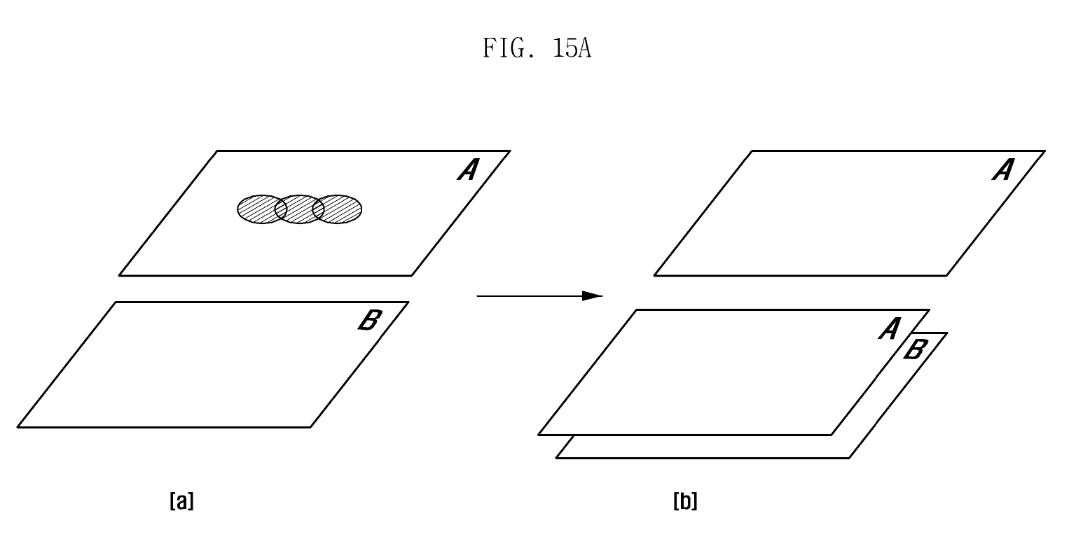

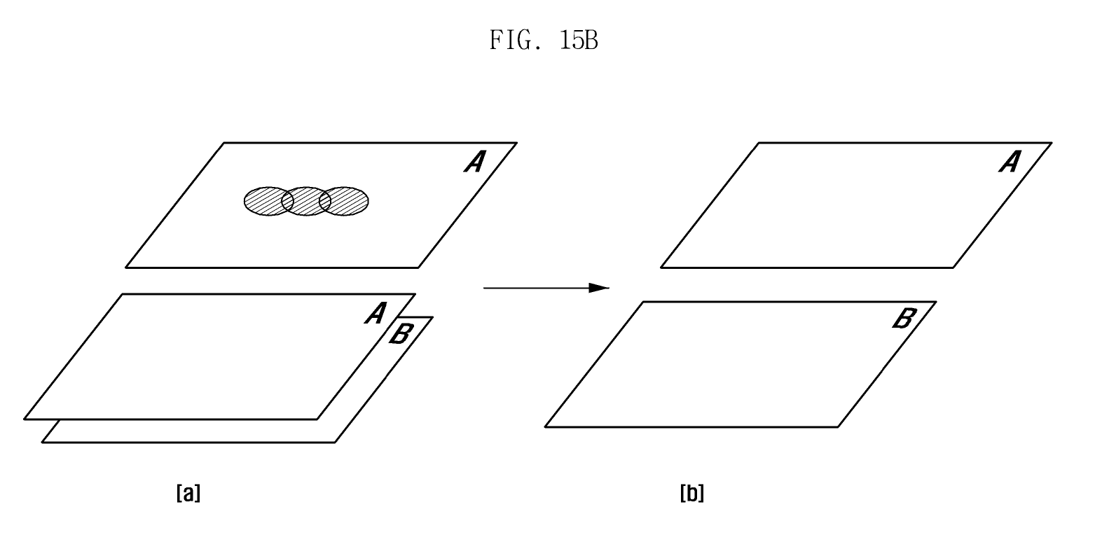

FIGS. 15A and 15B depict a screen display change on a first touch screen and a second touch screen according to an exemplary embodiment of the present invention.

Referring to FIG. 15A, reference symbol [a] depicts a situation in which a user makes a triple-tap gesture on the first touch screen 120 while the application A screen is displayed on the first touch screen 120 and the application B screen is displayed on the second touch screen 130. Reference symbol [b] of FIG. 15A depicts a screen display change after making the triple-tap gesture, in response to which the application A screen is displayed on both the first touch screen 120 and the second touch screen 130. On the second touch screen 130, the application B screen is placed below the application A screen.

Referring back to FIG. 14, the touch screen controller 171 determines whether a triple-tap gesture is made on the first touch screen 120 in step 1404. If it is determined that a triple-tap gesture is made on the first touch screen 120, the touch screen controller 171 reduces the application A screen so that the application A screen is displayed on the first touch screen 120 and the application B screen is displayed on the second touch screen 130 in step 1405.

Referring to FIG. 15B, reference symbol [a] depicts a situation in which a user makes a triple-tap gesture on the first touch screen 120 while the first touch screen 120 displays the application A screen and the second touch screen 130 displays the application A screen above the application B screen. Reference symbol [b] of FIG. 15B depicts screen display change after making the triple-tap gesture, in response to which the application A screen is displayed on the first touch screen 120 and the application B screen is displayed on the second touch screen 130.

As apparent from the above description, exemplary embodiments of the present invention enable a user to control multiple touch screens and to change screen display by means of simple touch gestures. The touch gestures are associated with intuitive actions of the user, thereby appealing to emotional sensitivity in the use of a mobile terminal.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A screen control method for a mobile terminal including multiple touch screens, the method comprising:
displaying at least one application screen on the touch screens;
detecting touch gestures made on the touch screens;
identifying the detected touch gestures made on the touch screens; and
changing at least one of application screens on the touch screens according to the identified touch gestures.

2. The screen control method of claim 1, wherein the multiple touch screens comprise a first touch screen and a second touch screen, and wherein the first touch screen is located above the second touch screen.

3. The screen control method of claim 2, wherein the identifying of the detected touch gestures comprises determining whether touch-point move gestures made on the first touch screen and the second touch screen are in the same direction.

4. The screen control method of claim 2, wherein the identifying of the detected touch gestures comprises determining whether touch-point move gestures made on the first touch screen and the second touch screen are both in at least one of the downward direction and the upward direction.

5. The screen control method of claim 4, wherein the displaying of the at least one application screen comprises displaying a first application screen on the first touch screen and displaying a second application screen on the second touch screen.

6. The screen control method of claim 5, wherein the changing of the at least one of application screens comprises:
enlarging, when the touch-point move gestures made on the first touch screen and the second touch screen are both in the downward direction, the first application screen so that the first application screen is displayed on both the first touch screen and the second touch screen; and
enlarging, when the touch-point move gestures made on the first touch screen and the second touch screen are both in the upward direction, the second application screen so that the second application screen is displayed on both the first touch screen and the second touch screen.

7. The screen control method of claim 4, wherein the displaying of the at least one application screen comprises displaying a first application screen on the first touch screen and the second touch screen, and placing a second application screen below the first application screen on at least one of the first touch screen and the second touch screen.

8. The screen control method of claim 7, wherein the changing of the at least one of the application screens comprises:
reducing, when the touch-point move gestures made on the first touch screen and the second touch screen are both in the downward direction, the first application screen so that the first application screen is displayed on the second touch screen and the second application screen is displayed on the first touch screen; and
reducing, when the touch-point move gestures made on the first touch screen and the second touch screen are both in the upward direction, the first application screen so that the first application screen is displayed on the first touch screen and the second application screen is displayed on the second touch screen.

9. The screen control method of claim 4, wherein the displaying of the at least one application screen comprises displaying a first application screen on the first touch screen and the second touch screen, placing a second application screen below the first application screen on the first touch screen, and placing a third application screen below the first application screen on the second touch screen.

10. The screen control method of claim 9, wherein the changing of the at least one of the application screens comprises:
reducing, when the touch-point move gestures made on the first touch screen and the second touch screen are both in the downward direction, the first application screen so that the first application screen is displayed on the second touch screen and the second application screen is displayed on the first touch screen; and
reducing, when the touch-point move gestures made on the first touch screen and the second touch screen are both in the upward direction, the first application screen so that the first application screen is displayed on the first touch screen and the third application screen is displayed on the second touch screen.

11. The screen control method of claim 4, wherein the displaying of the at least one application screen comprises displaying a first application screen on the first touch screen and the second touch screen.

12. The screen control method of claim 11, wherein the changing of the at least one of the application screens comprises:
reducing, when the touch-point move gestures made on the first touch screen and the second touch screen are both in the downward direction, the first application screen so that the first application screen is displayed on the second touch screen and a menu screen is displayed on the first touch screen; and
reducing, when the touch-point move gestures made on the first touch screen and the second touch screen are both in the upward direction, the first application screen so that the first application screen is displayed on the first touch screen and a menu screen is displayed on the second touch screen.

13. The screen control method of claim 2, wherein the displaying of the at least one application screen comprises displaying a first application screen on the first touch screen, and displaying a second application screen on the second touch screen.

14. The screen control method of claim 13, wherein the identifying of the detected touch gestures comprises one of determining whether a touch-point move gesture made on the first touch screen is in the downward direction and a touch-point move gesture made on the second touch screen is in the upward direction, and determining whether a touch-point move gesture made on the first touch screen is in the upward direction and a touch-point move gesture made on the second touch screen is in the downward direction.

15. The screen control method of claim 14, wherein the changing of the at least one of the application screens comprises conducting, when the touch-point move gesture made on the first touch screen is in the downward direction and the touch-point move gesture made on the second touch screen is in the upward direction, screen exchange so that the first application screen is displayed on the second touch screen and the second application screen is displayed on the first touch screen.

16. The screen control method of claim 14, wherein the changing of the at least one of the application screens comprises conducting, when the touch-point move gesture made on the first touch screen is in the upward direction and the touch-point move gesture made on the second touch screen is in the downward direction, screen change so that idle screens are displayed on the first touch screen and the second touch screen.

17. A mobile terminal comprising:
multiple touch screens for detecting touch gestures and for displaying application screens; and
a control unit for controlling the multiple touch screens to detect touch gestures, for identifying the detected touch gestures, and for changing at least one of application screens on the touch screens according to the identified touch gestures.

18. The mobile terminal of claim 17, wherein the multiple touch screens comprise a first touch screen and a second touch screen.

19. The mobile terminal of claim 18, wherein the control unit determines whether touch-point move gestures made on the first touch screen and the second touch screen are in the same direction, determines whether a touch-point move gesture made on the first touch screen is in a direction toward the second touch screen and another touch-point move gesture made on the second touch screen is in a direction toward the first touch screen, and determines whether a touch-point move gesture made on the first touch screen is in an opposite direction to the second touch screen and another touch-point move gesture made on the second touch screen is in an opposite direction to the first touch screen.

20. The mobile terminal of claim 19, wherein the control unit enlarges, when the touch-point move gestures made on the first touch screen and the second touch screen are in the same direction, an application screen displayed on at least one of the first touch screen and the second touch screen so that the application screen is displayed on both the first touch screen and the second touch screen.
